(19) United States
(12) Patent Application Publication
(10) Pub. No.: US 2003/0024284 A1
(43) Pub. Date: Feb. 6, 2003

(54) Method and apparatus for locking a water main valve

(76) Inventor: James E. Erickson, Orlando, FL (US)

Correspondence Address: William M. Hobby, III, Suite 375, 157 E. New England Avenue, Winter Park, FL, 32789, US

(21) Appl. No.: 09/918,201

(22) Filed: Jul. 31, 2001

(51) Int. Cl. G05G 1/00; F16K 35/00; G05G 5/00

(52) U.S. Cl. 70/177; 70/180

(57) ABSTRACT

A method and apparatus for locking a water main valve having a handle attached to a valve stem against unauthorized usage includes a method of selecting the apparatus which has a locking cover having a sidewall sized to enclose a portion of a water main valve which has an open bottom and a partially covered top and a first elongated locking arm extending therefrom. The selected apparatus also includes a second elongated locking arm having two ends and having a generally perpendicular yoke extending from one end thereof and having an opening in the other end thereof. The second elongated locking arm yoke is sized to fit under the water main valve handle over the water main valve stem. The method includes placing the second elongated arm yoke under the water main valve handle adjacent the valve stem and then placing a locking cover over the second elongated locking arm to cover a portion of the water main valve and then aligning the first and second locking arm openings for locking the locking arms together through the openings.

### BACKGROUND OF THE INVENTION

The present invention relates to valve locks and especially to a valve lock for locking a water main valve against unauthorized usage.

There has been a variety of locking devices for locking various types of valves which utilize a mechanical cover for locking of the valve handle to prevent unauthorized usage and tampering with the handle including unauthorized opening of the valve. The present invention is directed toward a water main valve lock which is simple in construction and inexpensive to manufacture and which allows a water main valve to be locked against unauthorized usage.

Prior art handle locking covers can be seen in the Callegari et al. U.S. Pat. No. 5,238,141 for an L.P. tank locking cover. The cover includes a base plate having a radial slot directed into the base plate to receive a handle stem of a handle of a conventional L.P. tank valve assembly. The base plate includes a cover cap hingedly mounted to the base plate and aligned relatively to a slot in the base plate. The cover cap includes cooperating flanges having apertures within the flanges to receive a locking member through the flanges to secure the cover cap to prevent access to the valve handle and unauthorized rotation of the valve handle. The Paris, Sr. U.S. Pat. No. 4,681,134 is a valve lock for a tank truck comprising an elongated straight length of strap metal having a shorter leg at each end projecting laterally in the same direction. The shorter leg at one end is secured to an upstream portion of the valve body which connects to a conduit leading from the tank of the truck. A shorter leg at the other end is releasably secured to the rotary valve handle to prevent movement from the valve closed position to the valve open position. The Primeau U.S. Pat. No. 5,598,724 is a butterfly valve safety lock for releasably locking the head of a butterfly valve. The Sackowitz U.S. Pat. No. 5,797,285 is a device for locking rotatable shafts having stop plates. The Bonomi U.S. Pat. No. 5,365,759 is a locking device which locks a rotary valve in the closed or open position. The Youngblood U.S. Pat. No. 3,980,099 is a valve guard to prevent deliberate tampering with or accidental movement of a rotatable valve handle and clamps to a pipe adjacent the valve to allow a pivotal cover to lock the valve handle. The Scheberl U.S. Pat. No. 2,838,064 is a safety guard for valves on outdoor faucets and covers a valve handle while locking a cover to the water pipe.

In contrast, the present invention is a simplified valve specifically made for locking a water main valve lock against rotation of the lock handle. The valve lock is conveniently formed of two separate components which can be rapidly attached to and over the water main valve handle. The two components are then locked together to prevent removal of the locking cover.

### SUMMARY OF THE INVENTION

A method and apparatus for locking a water main valve having a handle attached to a valve stem against unauthorized usage. The method includes selecting the apparatus which has a locking cover having a sidewall sized to enclose a water main valve handle. The cover has an open bottom and a partially covered top and a first elongated locking arm extending therefrom. The selected apparatus also includes a second elongated locking arm having two ends and having a generally perpendicular yoke extending from one end thereof and having an opening in the other end thereof. The second elongated locking arm yoke is sized to fit under the water main valve handle around the water main valve stem. The method includes placing the second elongated arm yoke under the water main valve handle adjacent the valve stem and then placing the locking cover over the second elongated locking arm to cover a portion of the water main valve and then aligning the first and second locking arm openings for locking the locking arms.

### BRIEF DESCRIPTION OF THE DRAWINGS

Other objects, features, and advantages of the present invention will be apparent from the written description and the drawings in which:

FIG. 1 is a perspective view of a water main valve lock in accordance with the present invention;

FIG. 2 is an exploded perspective of the water main valve lock of FIG. 1 and a water main valve lock;

FIG. 3 is a perspective view of a water main valve having a water main valve of FIGS. 1 and 2 attached thereto; and

FIG. 4 is a side elevation of the water main valve lock of FIGS. 1 through 3.

### DESCRIPTION OF THE PREFERRED EMBODIMENT

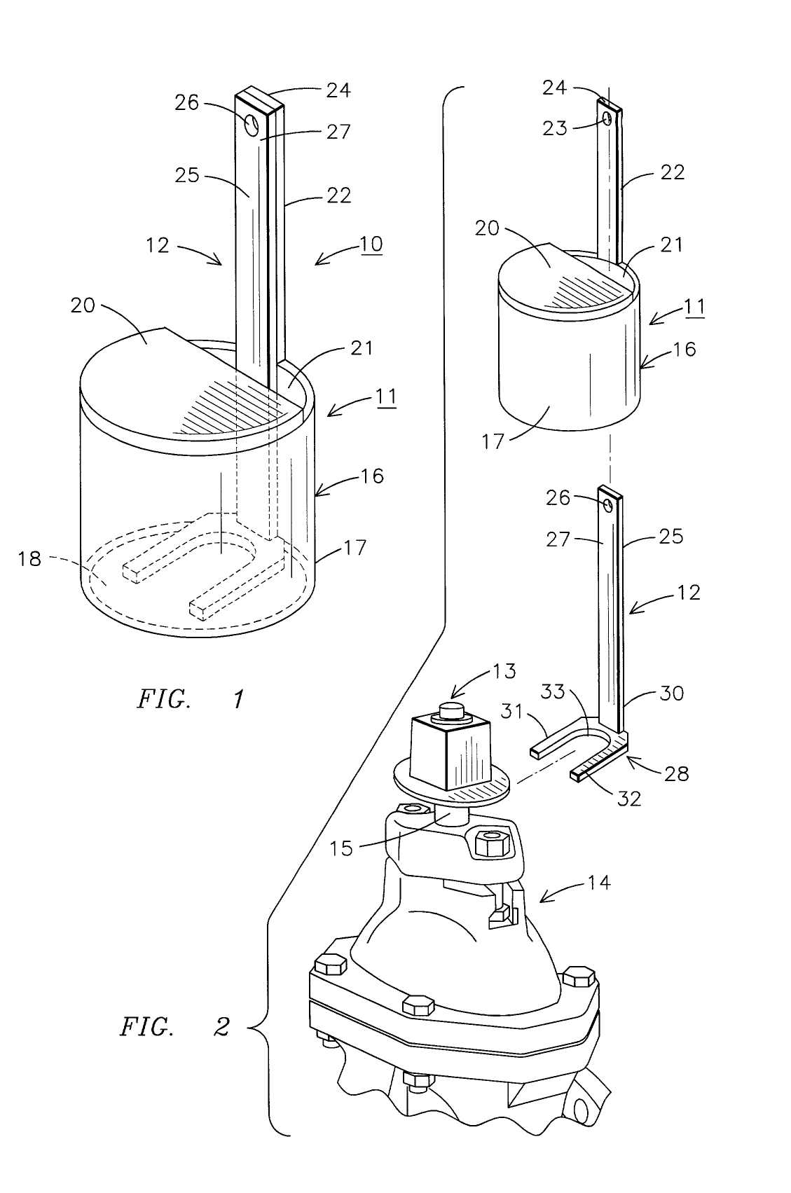

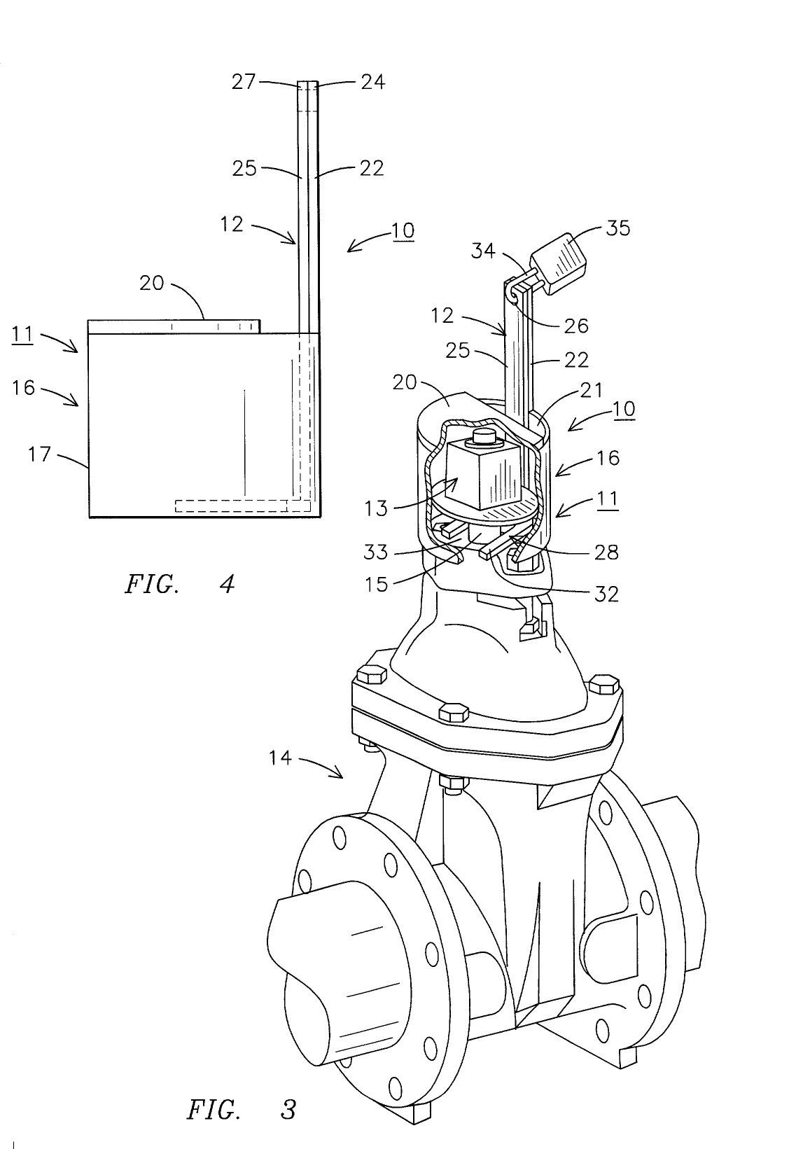

Referring to the drawings of FIGS. 1 through 4, a water main valve locking cover 10 has a water main valve handle cover 11 and a locking arm and yoke 12 for locking the handle on a rotating portion 13 of a water main valve 14. The handle portion 13 has a valve stem 15 to which it is connected. The valve handle cover 11 is a generally cylindrical valve handle cover 16 having sidewalls 17 with an open bottom 18 and a partially covered top 20. The partial cover 20 leaves an open area 21 adjacent an extending locking arm 22 having an opening 23 through the end portion 24. The locking arm 12 has an elongated portion 25 having an aperture 26 in the end portion 27 and has a perpendicular yoke 28 attached to the end 30 of the arm 25 and extending perpendicular therefrom. A perpendicular yoke 28 has a pair of arms 31 and 32 defining the yoke slot 33. The lock is attached to the water main valve 13 by sliding the elongated arm 12 yoke 28 under the handle 13 of the valve 14 with the open portion 33 around the valve stem 15. The valve handle cover 11 can then be slid over the locking arm 12 body 25, as shown in FIGS. 1, 3 and 4, with the arm portion 25 extending through the opening 21 to lower the cover 16 over the valve handle 13 as shown in FIG. 3. The extending arm 22 of the valve handle cover 11 can then align its aperture 23 with the adjacent arm portion 25 aperture 26, as shown in FIGS. 1, 3 and 4. Once in this aligned position, a lock 34 shackle 35 through the openings 23 in the elongated arm 22 and 26 in the arm 25. Once the components are locked together, as seen in FIG. 3, the handle 13 cover 11 is locked in a covered position so that the handle 13 can not be rotated for unauthorized use.

The process of the present invention includes the selecting of the locking cover 11 having a sidewall 17 sized to enclose a portion of a water main valve and especially the handle 13. The selected locking cover has an open bottom 18, a partially covered top 20, and a first elongated locking arm 22 extending therefrom and having an opening 23 therein. A second elongated locking arm 12 is then selected which has two end portions and has a generally perpendicular yoke 28 extending from one end portion and an opening 26 in the other end portion. The locking arm yoke 28 is sized to fit under a water main valve 14 handle 13 adjacent the water valve stem 15. The selected second elongated locking arm is then placed over the water main valve 14 under the valve handle 13 adjacent to or around the valve stem 15. The locking cover 11 is then placed over the elongated locking arm 12 and over the water main valve 14 handle 13 so that the locking arm 22 opening 23 can be aligned with the locking arm 25 opening 26 and a lock shackle 35 placed through the aligned first and second elongated arm openings for locking the arms together for preventing unauthorized usage of the water main valve 14 by the rotation of the valve handle 13.

It should be clear at this time that a method and apparatus for locking a water main valve handle from unauthorized usage has been provided. It will, however, be clear that the handle of a water main valve is typically shaped for engagement of a special wrench for turning the water main valve on and off by rotating of the valve stem. However, the present invention should not be construed as limited to the forms shown which are to be considered illustrative rather than restrictive.

I claim:

1. A method for locking a water main valve having a handle attached to a valve stem against unauthorized usage comprising the steps of:
selecting a locking cover having a sidewall sized to enclose said water main valve handle and said selected locking cover having a partially covered top and an open bottom, and having a first elongated locking arm extending therefrom having an opening therein;
selecting a second elongated locking arm having two end portions and having a generally perpendicular yoke extending from one end portion thereof and having an opening in the other end portion thereof, and said second elongated locking arm yoke being sized to fit under said water main valve handle and adjacent said water main valve stem;
placing said second locking arm yoke under said water main valve handle adjacent said valve stem;
placing said locking cover over said second elongated locking arm to cover said water main valve handle;
aligning said first locking arm opening with said second locking arm opening; and
placing a lock shackle through said aligned first and second elongated arms openings for locking said arms together for preventing unauthorized usage of said water main valve.

2. A method for locking a water main valve having a handle attached to a valve stem against unauthorized usage in accordance with claim 1 in which said selecting a valve cover includes selecting a valve cover having a generally cylindrical side wall.

3. A method for locking a water main valve having a handle attached to a valve stem against unauthorized usage in accordance with claim 2 in which said selecting a valve cover includes selecting a valve cover having a top cover open area adjacent said first elongated locking arm for passage of said second locking are therethrough.

4. A method for locking a water main valve having a handle attached to a valve stem against unauthorized usage in accordance with claim 3 in which said selecting a second elongated locking arm includes selecting a second elongated locking arm having a yoke sized to fit under said water main handle and over said valve stem.

5. A lock for a water main valve having a handle attached to a valve stem comprising:
a locking cover having a sidewall sized to enclose at least a water main valve handle and a covered top and an open bottom, and said locking cover having a first elongated locking arm extending therefrom having an opening therein; and
a second elongated locking arm having two end portions and having a generally perpendicular yoke extending from one end portion thereof and having an opening in the other end portion thereof, said second elongated locking arm yoke being sized to fit under said water main valve handle and adjacent said water main valve stem and said locking cover placed over said second elongated locking arm to cover said water main valve handle;
whereby said second elongated locking arm can be placed onto a water main valve under said valve handle and said locking cover placed over said water main valve handle and aligning said first elongated arm opening with said second elongated arm opening for placement of a lock shackle through said openings to lock said water main valve again unauthorized usage.

6. A lock for a water main valve having a handle attached to a valve stem in accordance with claim 5 in which said locking cover has a generally cylindrical sidewall.

7. A lock for a water main valve having a handle attached to a valve stem in accordance with claim 6 in which said locking covered top has an open area sized for said second elongated arm to pass through.
